(19) United States
(12) Patent Application Publication
(10) Pub. No.: US 2009/0088332 A1
(43) Pub. Date: Apr. 2, 2009

(54) Multiplex Digital Immuno-Sensing Using a Library of Photocleavable Mass Tags

(76) Inventors: Jingyue Ju, Englewood Cliffs, NJ (US); Xiaopeng Bai, New York, NY (US); Nicholas J. Turro, Tenafly, NJ (US)

Correspondence Address: COOPER & DUNHAM, LLP, 30 Rockefeller Plaza, 20th Floor, NEW YORK, NY, 10112, US

(21) Appl. No.: 12/085,343

(22) PCT Filed: Nov. 20, 2006
(86) PCT No.: PCT/US06/45180

§ 371 Date: May 19, 2008

Related U.S. Application Data
(60) Provisional application No. 60/738,765, filed on Nov. 21, 2005.

(51) Int. Cl. C40B 30/04; C40B 40/10

(52) U.S. Cl. 506/9; 506/18

(57) ABSTRACT

This invention provides methods, compositions and kits for immunosensing using photocleavable mass tags.

Throughout this application, various publications are referenced in parentheses by name or number. Full citations for these references may be found at the end of each experimental section. The disclosures of these publications in their entireties are hereby incorporated by reference into this application to more fully describe the state of the art to which this invention pertains.

### BACKGROUND OF THE INVENTION

Genomics and proteomics are driving forces for new biological discoveries. With the completion of the human genome project (1), researchers are applying this wealth of DNA sequence information to solve unique problems in proteomics. The challenges mostly lie in the characterization of every protein encoded by the human genome, including understanding its structure, function, molecular interactions and regulation in various cell types. The individuality of proteins is indicated by the different types, which number in the thousands, with each protein possessing unique properties. This highlights the need for analytical methods that can satisfy the high throughput and accuracy demanded for this area, especially methods capable of the simultaneous detection of multiple analytes.

A variety of tools have been developed to meet these challenges, employing a diverse range of disciplines ranging from biochemistry, chemistry, physics and material science to microelectronics (2). Among them, the technologies based on the antibody-antigen interaction have emerged to be promising to meet the requirements of these assays because of the specificity and sensitivity of the interaction.

Antibodies are proteins produced by an organism's immune system in response to the presence of foreign substances, antigens. Antibodies have specific affinity for the antigens that elicited their synthesis. The ability of an antibody to interact with its respective antigen has long been a target for manipulation using the immune system of various organisms because it is possible to obtain antibodies that are specific to a desired target molecule, which forms the basis of immuno-sensing technologies that are specific, sensitive and reproducible.

Most of the immuno-sensing methods available presently are based on the microarray assay format (3). The first immunoassay principles (4) were reported almost 60 years after the characterization of the antibody-antigen interaction in 1900 (5). The discovery of the methods to produce monoclonal antibodies (6) of almost any desired specificity made it possible to develop the immunoassay with higher specificity and affinity. In a solid-phase immunoassay, an antibody specific for a protein of interest is attached to a solid support such as a sheet of polyvinylchloride. The remaining surface is then blocked before the test sample is applied. A drop of cell extract or a sample of serum or urine is laid on the sheet, which is washed after formation of antibody-antigen complex. Antibody specific for a different site on the antigen is then added. This secondary antibody carries a radioactive or fluorescent label so that it can be detected. The amount of the secondary antibody bound to the surface is proportional to the quantity of antigen in the sample. The sensitivity of the assay can be further enhanced if the secondary antibody is attached to an enzyme that can convert many molecules of an added colorless substrate into colored products, or nonfluorescent substrates into intensely fluorescent products. This enzyme-linked immunosorbant assay (ELISA), has been used to detect less than 10⁻⁹ g of a protein.

Although array-based approaches have become popular tools for biochemistry and molecular biology, limitations still remain which make them incapable of routine use for diagnostic and medical purposes. The preparation of arrays with a diverse set of protein families is still difficult. For example, fluorescence based detection methods suffer from photobleaching, and the limited availability of fluorescent dyes with distinguishable emission wavelength also makes it difficult for multiplex detection. Radioactivity based detection is undesirable for safety reasons. The methods utilizing MALDI-TOF mass spectrometry (7) and surface-plasmon resonance (SPR) spectroscopy (8) are now under rapid development, but no satisfactory success has yet been demonstrated.

### SUMMARY OF THE INVENTION

This invention provides a method for detecting the presence of an agent in a sample comprising:
(a) contacting the sample with a solid substrate having affixed thereto a first antibody which binds to the agent, wherein the contacting is performed under conditions which would permit the first antibody to bind to the agent if present in the sample;
(b) removing any unbound sample from the solid substrate;
(c) contacting the solid substrate with a second antibody which binds to the agent concurrently with the first antibody, wherein the second antibody has a mass tag cleavably affixed thereto, and wherein the contacting is performed under conditions which would permit the second antibody to bind to the agent if present in the sample;
(d) removing any unbound second antibody;
(e) cleaving the mass tag from any bound second antibody; and
(f) detecting the presence of any cleaved mass tag,
   wherein the presence of cleaved mass tag indicates that the agent is present in the sample.

This invention also provides a second method for detecting the presence of one or more of a plurality of agents in a sample comprising:
(a) contacting the sample with a solid substrate having affixed thereto a plurality of first antibodies, wherein (i) for each agent whose presence in the sample is being detected, there is at least one first antibody which binds to the agent, and (ii) the contacting is performed under conditions which would permit each first antibody to bind to its respective agent if present in the sample;
(b) removing any unbound sample from the solid substrate;
(c) contacting the solid substrate with a plurality of second antibodies, wherein (i) each second antibody has a mass tag of predetermined mass cleavably affixed thereto, (ii) the contacting is performed under conditions which would permit each second antibody to bind to its respective agent if present in the sample, and (iii) for each agent whose presence in the sample is being detected, there is at least one second antibody which binds to the agent concurrently with its respective first antibody or antibodies, and the mass tag or mass tags bound to the second antibody or antibodies, respectively, which bind to that agent have a different mass than that of the mass tag bound to any second antibody which binds to any other agent;
(d) removing any unbound second antibodies;
(e) cleaving the mass tags from any bound second antibodies; and
(f) detecting the presence and determining the mass of any cleaved mass tag,
whereby, for each agent whose presence in the sample is being detected, the presence of a mass tag cleaved from a second antibody that binds to the agent indicates that the agent is present in the sample.

This invention further provides a third method for detecting the presence of an agent in a sample comprising:
(a) contacting the sample with a solid substrate which binds to the agent, wherein the contacting is performed under conditions which would permit the solid substrate to bind to the agent if present in the sample;
(b) removing any unbound sample from the solid substrate;
(c) contacting the solid substrate with an antibody which binds to the agent concurrently with the solid substrate, wherein the antibody has a mass tag cleavably affixed thereto, and wherein the contacting is performed under conditions which would permit the antibody to bind to the agent if present in the sample;
(d) removing any unbound antibody;
(e) cleaving the mass tag from any bound antibody; and
(f) detecting the presence of any cleaved mass tag,
wherein the presence of cleaved mass tag indicates that the agent is present in the sample.

This invention further provides a fourth method for detecting the presence of one or more of a plurality of agents in a sample comprising:
(a) contacting the sample with a solid substrate which binds to each agent whose presence in the sample is being detected, wherein the contacting is performed under conditions which would permit the solid substrate to bind to each agent if present in the sample;
(b) removing any unbound sample from the solid substrate;
(c) contacting the solid substrate with a plurality of antibodies, wherein (i) each antibody has a mass tag of predetermined mass cleavably affixed thereto, (ii) the contacting is performed under conditions which would permit each antibody to bind to its respective agent if present in the sample, and (iii) for each agent whose presence in the sample is being detected, there is at least one antibody which binds to the agent concurrently with the solid substrate, and the mass tag or mass tags bound to the antibody or antibodies, respectively, which bind to that agent have a different mass than that of the mass tag bound to any antibody which binds to any other agent;
(d) removing any unbound antibodies;
(e) cleaving the mass tags from any bound antibodies; and
(f) detecting the presence and determining the mass of any cleaved mass tag,
whereby, for each agent whose presence in the sample is being detected, the presence of a mass tag cleaved from an antibody that binds to the agent indicates that the agent is present in the sample.

This invention also provides a composition of matter comprising:
(a) a solid substrate;
(b) a first antibody bound to the solid substrate, wherein the first antibody recognizes an agent;
(c) the agent recognized by the first antibody, wherein the agent is bound to the first antibody; and
(d) a second antibody which recognizes the agent bound concurrently to the first antibody, wherein the second antibody is bound to the agent, and wherein the second antibody has a mass tag cleavably affixed thereto

This invention further provides a first kit for detecting the presence of an agent in a sample comprising:
(a) a solid substrate;
(b) a first antibody for affixing to the solid substrate, which first antibody recognizes the agent;
(c) a second antibody having a mass tag cleavably affixed thereto, which second antibody recognizes the agent concurrently with the first antibody; and
(d) instructions for using the kit to detect the presence of the agent in the sample.

This invention further provides a second kit for detecting the presence of an agent in a sample comprising:
(a) a solid substrate having affixed thereto a first antibody which recognizes the agent;
(b) a second antibody having a mass tag cleavably affixed thereto, which second antibody recognizes the agent concurrently with the first antibody; and
(c) instructions for using the kit to detect the presence of the agent in the sample.

This invention further provides a third kit for detecting the presence of an agent in a sample comprising:
(a) a solid substrate which binds the agent;
(b) an antibody having a mass tag cleavably affixed thereto, which antibody recognizes the agent; and
(c) instructions for using the kit to detect the presence of the agent in the sample.

This invention further provides a fourth kit for detecting the presence of one or more of a plurality of agents in a sample comprising:
(a) a solid substrate;
(b) a plurality of first antibodies for affixing to the solid substrate wherein for each agent whose presence is being detected in the sample there is at least one first antibody which binds to the agent;
(c) a plurality of second antibodies each having a mass tag cleavably affixed thereto, wherein for each agent whose presence in the sample is to be detected, there is at least one second antibody which binds to the agent concurrently with its respective first antibody, and the mass tag or mass tags bound to the second antibody or antibodies, respectively, which bind to that agent have a different mass than that of the mass tag bound to any second antibody which binds to any other agent; and
(d) instructions for using the kit to detect the presence in the sample of one or more agents.

This invention further provides a fifth kit for detecting the presence in a sample of one or more of a plurality of agents comprising:
(a) a solid substrate having a plurality of first antibodies affixed thereto wherein for each agent whose presence in the sample is being detected, there is at least one first antibody which binds to the agent;
(b) a plurality of second antibodies each having a mass tag cleavably affixed thereto, wherein for each agent whose presence in the sample is to be detected, there is at least one second antibody which binds to the agent concurrently with its respective first antibody, and the mass Lag or mass tags bound to the second antibody or antibodies, respectively, which bind to that agent have a different mass than that of the mass tag bound to any second antibody which binds to any other agent; and
(c) instructions for using the kit to detect the presence in the sample of one or more agents.

Finally, this invention provides a sixth kit for detecting the presence of one or more of a plurality of agents in a sample comprising:
(a) a solid substrate which binds each of the agents whose presence is to be detected;
(b) a plurality of antibodies each having a mass tag cleavably affixed thereto, wherein for each agent whose presence in the sample is being detected, there is at least one antibody which binds to the agent; and
(c) instructions for using the kit to detect the presence in the sample of one or more agents.

### BRIEF DESCRIPTION OF THE FIGURES

FIG. 1. Schematic of simultaneous immunosensing of different antigens using photocleaveable mass tag-labeled antibodies.

FIG. 2. Synthesis of four different photocleavable mass tag NHS esters.

FIG. 3. Photocleavage of photocleavable mass tag labeled detection antibodies under irradiation with U.V. Light at about 340 nm.

### DETAILED DESCRIPTION OF THE INVENTION

### Terms

The following terms are presented as an aid in understanding this invention:

| | |
|---|---|
| APCI | Atmospheric Pressure Chemical Ionization; |
| PC | Photocleaveable |
| SEB | Staphylococcal Enterotoxin B |
| UV | Ultra Violet |

“Agent” shall mean an entity, e.g. one present in a biological sample, which is recognized by an antibody. Agents include, for example, a polypeptide or an antigenic fragment of a polypeptide, a glycomer, a lectin, a nucleic acid, a bacterium, a virus, and any combination thereof.

“Antibody” shall include, without limitation, (a) an immunoglobulin molecule comprising two heavy chains and two light chains and which recognizes an antigen; (b) a polyclonal or monoclonal immunoglobulin molecule; and (c) a monovalent or divalent fragment thereof. Immunoglobulin molecules may derive from any of the commonly known classes, including but not limited to IgA, secretory IgA, IgG, IgE and IgM. IgG subclasses are well known to those in the art and include, but are not limited to, human IgG1, IgG2, IgG3 and IgG4. Antibodies can be both naturally occurring and non-naturally occurring. Furthermore, antibodies include chimeric antibodies, wholly synthetic antibodies, single chain antibodies, and fragments thereof. Antibodies may be human or nonhuman. Antibody fragments include, without limitation, Fab fragments, Fv fragments and other antigen-binding fragments.

“Mass tag” shall mean a molecular entity of a predetermined size which is capable of being attached by a cleavable bond to another entity.

“Solid substrate” shall mean any suitable medium present in the solid phase to which an antibody or an agent may be affixed.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

### EMBODIMENTS OF THE INVENTION

This invention relates to a novel multiplex digital immuno-sensing approach that is based on the detection of photocleavable mass tags by Atmospheric Pressure Chemical Ionization (APCI) mass spectrometry. The mass tags have unique mass values and can be detected with almost real-time response. The whole process can be performed in a small vial for the simultaneous detection of multiple analytes, facilitating easy and rapid measurement. The success of this approach permits use of immuno-sensing systems for various applications.

Specifically, this invention provides a first method for detecting the presence of an agent in a sample comprising:
(a) contacting the sample with a solid substrate having affixed thereto a first antibody which binds to the agent, wherein the contacting is performed under conditions which would permit the first antibody to bind to the agent if present in the sample;
(b) removing any unbound sample from the solid substrate;
(c) contacting the solid substrate with a second antibody which binds to the agent concurrently with the first antibody, wherein the second antibody has a mass tag cleavably affixed thereto, and wherein the contacting is performed under conditions which would permit the second antibody to bind to the agent if present in the sample;
(d) removing any unbound second antibody;
(e) cleaving the mass tag from any bound second antibody; and
(f) detecting the presence of any cleaved mass tag,
   wherein the presence of cleaved mass tag indicates that the agent is present in the sample.

This invention also provides a second method for detecting the presence of one or more of a plurality of agents in a sample comprising:
(a) contacting the sample with a solid substrate having affixed thereto a plurality of first antibodies, wherein (i) for each agent whose presence in the sample is being detected, there is at least one first antibody which binds to the agent, and (ii) the contacting is performed under conditions which would permit each first antibody to bind to its respective agent if present in the sample;
(b) removing any unbound sample from the solid substrate;
(c) contacting the solid substrate with a plurality of second antibodies, wherein (i) each second antibody has a mass tag of predetermined mass cleavably affixed thereto, (ii) the contacting is performed under conditions which would permit each second antibody to bind to its respective agent if present in the sample, and (iii) for each agent whose presence in the sample is being detected, there is at least one second antibody which binds to the agent concurrently with its respective first antibody or antibodies, and the mass tag or mass tags bound to the second antibody or antibodies, respectively, which bind to that agent have a different mass than that of the mass tag bound to any second antibody which binds to any other agent;
(d) removing any unbound second antibodies;
(e) cleaving the mass tags from any bound second antibodies; and
(f) detecting the presence and determining the mass of any cleaved mass tag,
   whereby, for each agent whose presence in the sample is being detected, the presence of a mass tag cleaved from a second antibody that binds to the agent indicates that the agent is present in the sample.

This invention also provides a third method for detecting the presence of an agent in a sample comprising:
(a) contacting the sample with a solid substrate which binds to the agent, wherein the contacting is performed under conditions which would permit the solid substrate to bind to the agent if present in the sample;
(b) removing any unbound sample from the solid substrate;
(c) contacting the solid substrate with an antibody which binds to the agent concurrently with the solid substrate, wherein the antibody has a mass tag cleavably affixed thereto, and wherein the contacting is performed under conditions which would permit the antibody to bind to the agent if present in the sample;
(d) removing any unbound antibody;
(e) cleaving the mass tag from any bound antibody; and
(f) detecting the presence of any cleaved mass tag,
   wherein the presence of cleaved mass tag indicates that the agent is present in the sample.

This invention also provides a fourth method for detecting the presence of one or more of a plurality of agents in a sample comprising:
(a) contacting the sample with a solid substrate which binds to each agent whose presence in the sample is being detected, wherein the contacting is performed under conditions which would permit the solid substrate to bind to each agent if present in the sample;
(b) removing any unbound sample from the solid substrate;
(c) contacting the solid substrate with a plurality of antibodies, wherein (i) each antibody has a mass tag of predetermined mass cleavably affixed thereto, (ii) the contacting is performed under conditions which would permit each antibody to bind to its respective agent if present in the sample, and (iii) for each agent whose presence in the sample is being detected, there is at least one antibody which binds to the agent concurrently with the solid substrate, and the mass tag or mass tags bound to the antibody or antibodies, respectively, which bind to that agent have a different mass than that of the mass tag bound to any antibody which binds to any other agent;
(d) removing any unbound antibodies;
(e) cleaving the mass tags from any bound antibodies; and
(f) detecting the presence and determining the mass of any cleaved mass tag,
   whereby, for each agent whose presence in the sample is being detected, the presence of a mass tag cleaved from an antibody that binds to the agent indicates that the agent is present in the sample.

In one embodiment of each of the instant methods, the sample is an aqueous cell suspension, a cell lysate, blood, plasma, lymph, cerebro-spinal fluid, tears, saliva, urine, synovial fluid, or a fluid derived from any of the above. In another embodiment, the sample is of mammalian origin, preferably of human origin. In another embodiment, the sample is of avian origin.

In one embodiment of each of the instant methods, each antibody is a monoclonal antibody, e.g., a chimeric monoclonal antibody.

In another embodiment of the instant methods, the cleavable mass tag can be cleaved chemically, by ultraviolet light, by heat, or by laser. In another embodiment, the cleaved mass tag is detected by mass spectrometry. The mass spectrometry can be, for example, atmospheric pressure chemical ionization mass spectrometry, electrospray ionization mass spectrometry, or matrix assisted laser desorption ionization mass spectrometry.

In a further embodiment of the instant methods, the solid substrate is glass, quartz, silicon, plastic, or gold, and can be for example, in the form of a bead, a chip, or a well. In this invention, each antibody affixed to a solid substrate can be affixed, for example, via a streptavidin-biotin link or via 1,3-dipolar cycloaddition. In the instant methods, the agent detected can be, for example, a bacterial antigen or a viral antigen. In one embodiment of the instant methods, each mass tag has a molecular weight of from about 100 Da to about 2,500 Da. In one embodiment, one mass tag has the structure:

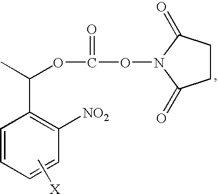

wherein X is H, F, OMe, or (OMe)₂.

This invention also provides a composition of matter comprising: (a) a solid substrate; (b) a first antibody bound to the solid substrate, wherein the first antibody recognizes an agent; (c) the agent recognized by the first antibody, wherein the agent is bound to the first antibody; and (d) a second antibody which recognizes the agent bound concurrently to the first antibody, wherein the second antibody is bound to the agent, and wherein the second antibody has a mass tag cleavably affixed thereto.

This invention further provides a first kit for detecting the presence of an agent in a sample comprising: (a) a solid substrate; (b) a first antibody for affixing to the solid substrate, which first antibody recognizes the agent; (c) a second antibody having a mass tag cleavably affixed thereto, which second antibody recognizes the agent concurrently with the first antibody; and (d) instructions for using the kit to detect the presence of the agent in the sample.

This invention also provides a second kit for detecting the presence of an agent in a sample comprising: (a) a solid substrate having affixed thereto a first antibody which recognizes the agent; (b) a second antibody having a mass tag cleavably affixed thereto, which second antibody recognizes the agent concurrently with the first antibody; and (c) instructions for using the kit to detect the presence of the agent in the sample.

This invention also provides a third kit for detecting the presence of an agent in a sample comprising: (a) a solid substrate which binds the agent; (b) an antibody having a mass tag cleavably affixed thereto, which antibody recognizes the agent; and (c) instructions for using the kit to detect the presence of the agent in the sample.

This invention also provides a fourth kit for detecting the presence of one or more of a plurality of agents in a sample comprising: (a) a solid substrate; (b) a plurality of first antibodies for affixing to the solid substrate wherein for each agent whose presence is being detected in the sample there is at least one first antibody which binds to the agent; (c) a plurality of second antibodies each having a mass tag cleavably affixed thereto, wherein for each agent whose presence in the sample is to be detected, there is at least one second antibody which binds to the agent concurrently with its respective first antibody, and the mass tag or mass tags bound to the second antibody or antibodies, respectively, which bind to that agent have a different mass than that of the mass tag bound to any second antibody which binds to any other agent; and (d) instructions for using the kit to detect the presence in the sample of one or more agents.

This invention also provides a fifth kit for detecting the presence in a sample of one or more of a plurality of agents comprising: (a) a solid substrate having a plurality of first antibodies affixed thereto wherein for each agent whose presence in the sample is being detected, there is at least one first antibody which binds to the agent; (b) a plurality of second antibodies each having a mass tag cleavably affixed thereto, wherein for each agent whose presence in the sample is to be detected, there is at least one second antibody which binds to the agent concurrently with its respective first antibody, and the mass tag or mass tags bound to the second antibody or antibodies, respectively, which bind to that agent have a different mass than that of the mass tag bound to any second antibody which binds to any other agent; and (c) instructions for using the kit to detect the presence in the sample of one or more agents.

Finally, this invention provides a sixth kit for detecting the presence of one or more of a plurality of agents in a sample comprising: (a) a solid substrate which binds each of the agents whose presence is to be detected; (b) a plurality of antibodies each having a mass tag cleavably affixed thereto, wherein for each agent whose presence in the sample is being detected, there is at least one antibody which binds to the agent; and (c) instructions for using the kit to detect the presence in the sample of one or more agents.

In one embodiment of each of the instant kits, the sample is an aqueous cell suspension, a cell lysate, blood, plasma, lymph, cerebro-spinal fluid, tears, saliva, urine, synovial fluid, or a fluid derived from any of the above. In another embodiment, the sample is of mammalian origin, preferably of human origin. In another embodiment, the sample is of avian origin.

In one embodiment of each of the instant kits, each antibody is a monoclonal antibody, e.g., a chimeric monoclonal antibody.

In another embodiment of the instant kits, the cleavable mass tag is cleaved chemically, by ultraviolet light, by heat, or by laser. In another embodiment, the cleaved mass tag is detected by mass spectrometry. The mass spectrometry can be, for example atmospheric pressure chemical ionization mass spectrometry, electrospray ionization mass spectrometry, or matrix assisted laser desorption ionization mass spectrometry.

In a further embodiment of the instant kits, the solid substrate is glass, quartz, silicon, plastic, or gold, and can be for example, in the form of a bead, a chip, or a well. In this invention, each antibody affixed to a solid substrate can be affixed, for example, via a streptavidin-biotin link or via 1,3-dipolar cycloaddition. In the instant kits, the agent detected can be, for example, a bacterial antigen or a viral antigen. In one embodiment of the instant kits, each mass tag has a molecular weight of from about 100 Da to about 2,500 Da. In one embodiment, one mass tag has the structure:

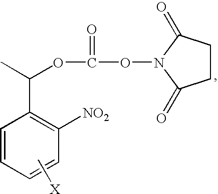

wherein X is H, F, OMe, or (OMe)₂.

This invention will be better understood by reference to the Experimental Details which follow, but those skilled in the art will readily appreciate that the specific experiments detailed are only illustrative of the invention as described more fully in the claims which follow thereafter.

### Experimental Details

Here we disclose the design and synthesis of a library of photocleavable mass tags that can be conjugated to a variety of antibodies. The mass tags are designed so that they can be cleaved by irradiation with near-UV light (˜340 nm) after conjugation with antibodies, and the photocleavage products can be detected by Atmospheric Pressure Chemical Ionization (APCI) mass spectrometry. In addition, screening the binding reactivity of photocleavable mass tag-labeled antibodies for their corresponding antigens is disclosed here, as well as the use of the photocleavable mass tag-labeled antibodies, biotin-labeled antibodies, streptavidin-coated solid surfaces and a mass spectrometer in a system that is capable of multiplex digital immuno-sensing.

In one embodiment of the immuno-sensing method disclosed here, the immobilization of the biotin-labeled antibodies to a streptavidin-coated solid surface and subsequent blocking of the remaining surface before test antigens are applied is employed. The antigens that are captured by the immobilized antibodies can be identified by the addition of a second set of photocleavable mass tag-labeled antibodies that recognize a different epitope of the antigens. The identity of the captured antigens can be revealed by the unique mass values associated with mass tags generated by UV irradiation on the solid surface. In one embodiment, the whole process is performed in one tube, allowing rapid detection for multiple analytes.

### Design of a Multiplex Immuno-Sensing Method Using Photocleavable Mass Tags

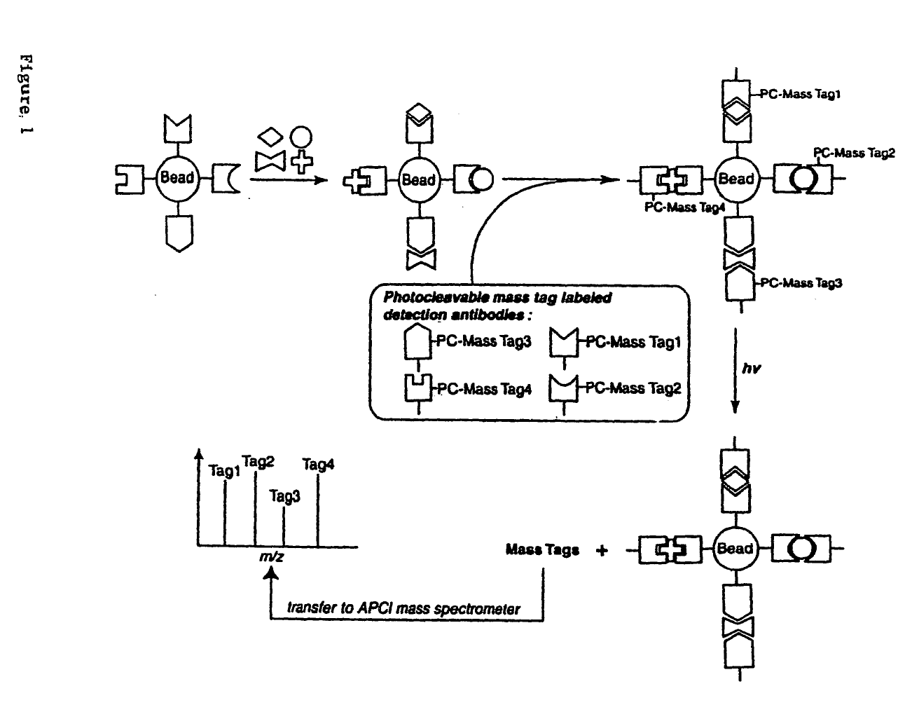

One embodiment of the immuno-sensing method using photocleavable mass tags is shown in FIG. 1. The system consists of a solid support (such as beads with large surface area) with immobilized antibodies as capture antibodies that are able to bind to their specific target antigens in complex biological solutions, such as a cell extract. Upon adding the sample solution containing various antigens, only the antigens that can interact with the immobilized antibodies will be bound to the solid surface. After removing excess reagents and washing away any unbound proteins on the solid surface, the photocleavable mass tag-labeled detection antibodies are added, each of which can interact with a different epitope on the antigens. After washing away the excess reagents from the solid surface, UV irradiation is applied to cleave the photocleavable mass tags from the antibody-antigen complex on the surface. The mass tags that are released into the solution are identified by an APCI mass spectrometer. For initial experiments, four kinds of antigens and their corresponding antibodies are used to validate the whole process. Streptavidin-coated magnetic beads are used as the solid surface to bind the biotinylated capture antibodies. The entire process is performed in a small vial and capillary tubing is used to transfer the solution into an APCI mass spectrometer for detection.

### Synthesis of Biotinylated Antibodies as Capture Antibodies

Four target antigens and corresponding antibodies are used for initial experiments: staphylococcal enterotoxin B (SEB) and rabbit anti-SEB IgG (Toxin Technology, Sarasota, Fla.), plague Fl antigen and monoclonal antibody YPF-6H3-1-1-IgG (6H3) (9), D-dimer and monoclonal DD-3B6/22 (capture) and DD-4D2/182 (detection) (Agen Biomedical Ltd, Brisbane, Australia), Chicken IgY and rabbit anti-chicken antibody (Jackson Immuno-Research, West Grove, Calif.). All the samples used here are of diagnostic importance and the need for rapid detection has been validated. Biotin is introduced onto the hinge sulfhydryl group of DD-3B6/22 Fab′ fragment according to Savage et al. (10). Anti-SEB IgG, 6H3 and rabbit anti-chicken antibody are labeled with biotin-LC-N-hydroxysuccinimidyl ester (Pierce, Rockford, Ill.) at pH=9 at a 5:1 ratio (biotin:antibody) (10); unincorporated biotin is removed from labeled proteins by dialysis or gel filtration.

### Synthesis of Photocleavable Mass Tag-Labeled Detection Antibodies

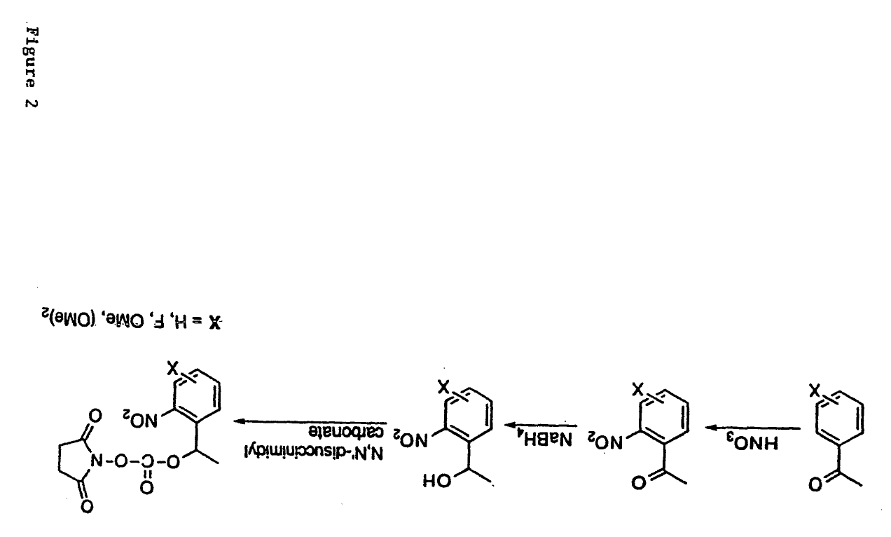

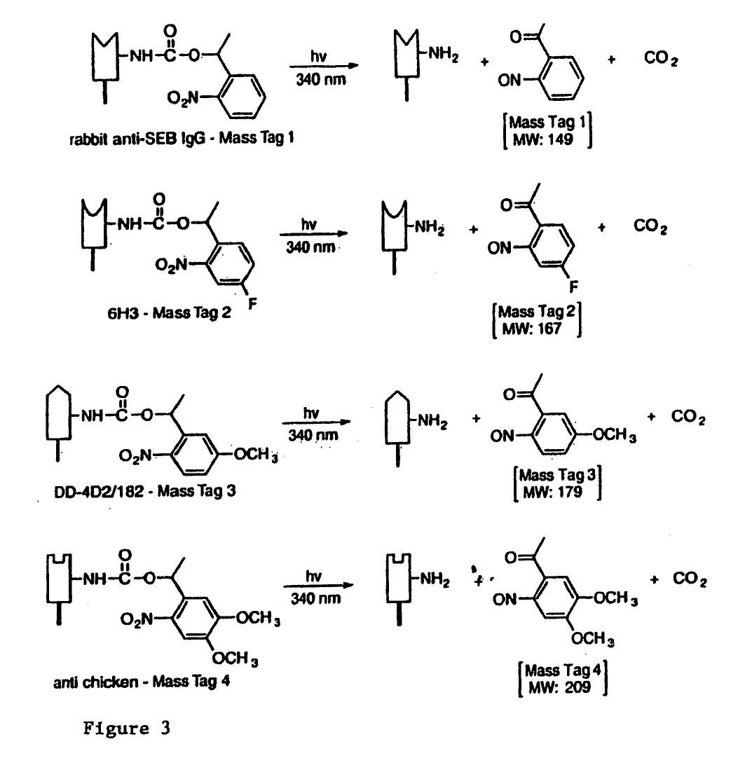

Four detection antibodies can be synthesized by attaching a unique photocleavable mass tag label to each one. The synthesis of four active photocleavable mass tag NHS esters is shown in FIG. 2. Each of these four mass tag NHS esters can be introduced to each of the four antibodies mentioned above by a similar procedure (10). The photocleavable 2-nitrobenzyl moiety has previously been used for a variety of applications (11) and can be efficiently cleaved by UV irradiation with a wavelength above 320 nm under which the proteins will not be damaged. The photocleavage reaction of the mass tag-labeled detection antibodies is shown in FIG. 3. The unique mass value of the photocleavage product 2-nitroso derivative serves as a unique mass tag for each of the four detection antibodies.

### Immuno-Sensing Using the Mass Tag-Labeled Detection Antibodies

Streptavidin-coated magnetic beads (Seradyn, Indianapolis) can be used as the solid surface to bind the biotinylated capture antibodies. Ideally, the binding of each of the four biotinylated capture antibodies is done separately and bovine serum albumin (BSA) can be used to block the remaining surface to prevent unspecific binding. A portion of each solution is mixed in a small test tube to assure that all the four biotinylated capture antibodies are evenly distributed in solution. After the sample solution that contains one or several antigens is added to the test tube and incubated for binding, the excess reagents are washed away and then the photocleavable mass tag-labeled detection antibodies are introduced into the system. The solid phase beads are then rinsed again to remove all the unbound detection antibodies. UV irradiation can then be applied to cleave the tags. The solution containing the cleaved mass tags is transferred into the APCI mass spectrometer for measurement to give the identity of the bound antibodies and therefore the identity of the bound antigens. FIG. 3 shows photocleavage of photocleavable mass tag-labeled detection antibodies under irradiation of with UV light (˜340 nm).

Multiple photocleavable mass tag-labeled detection antibodies, with a unique mass tag for each of the antibodies being assayed, permits high multiplexing immunoassays.

### REFERENCES

1. Science, (2003) issue of April 11; Nature, (2003) issue of April 24.
2. Phizicky, E., Bastiaens, P. I. H., Zhu, H., Snyder, M. & Fields, S. Nature (2003) 422, 208-215.
3. Kodadek, T. Chem. Biol. (2001) 8, 105-115.
4. Ya low, R. S. & Berson, S. A. Nature (1959) 184, 1648-1649.
5. Ehrlich, P. Proc. R. Soc. London, (1900) 66, 424.
6. Kohler, G. & Milstein, C. A, Nature, (1975) 256, 495-497.
7. Gygi, S. P., Rist, B., Gerber, S. A., Turecek, F., Gelb, M. H. & Aebersold, R. Nat. Biotechnol. (1999) 17, 949-999.
8. Cooper, M. A. Nat. Rev. Drug. Discov. (2002) 1, 515-528.
9. Cao, L. K., Anderson, G. P., Ligler, F. S. & Ezzell, J. J. Clin. Microbiol. (1995) 33, 336-41.
10. Savage, D., Mattson, G., Desai, S., Nielander, G., Morgensen, S. & Conklin, E. Avidin-Biotin Chemistry: A handbook. (1992) Pierce: Rockford, Ill.
11. Guillier, F., Orain, D. & Bradley, M. Chem. Rev. (2000) 100, 2091-2157.

1. A method for detecting the presence of an agent in a sample comprising:
(a) contacting the sample with a solid substrate having affixed thereto a first antibody which binds to the agent, wherein the contacting is performed under conditions which would permit the first antibody to bind to the agent if present in the sample;
(b) removing any unbound sample from the solid substrate;
(c) contacting the solid substrate with a second antibody which binds to the agent concurrently with the first antibody, wherein the second antibody has a mass tag cleavably affixed thereto, and wherein the contacting is performed under conditions which would permit the second antibody to bind to the agent if present in the sample;
(d) removing any unbound second antibody;
(e) cleaving the mass tag from any bound second antibody; and
(f) detecting the presence of any cleaved mass tag,
wherein the presence of cleaved mass tag indicates that the agent is present in the sample.

2. (canceled)

3. A method for detecting the presence of an agent in a sample comprising:
(a) contacting the sample with a solid substrate which binds to the agent, wherein the contacting is performed under conditions which would permit the solid substrate to bind to the agent if present in the sample;
(b) removing any unbound sample from the solid substrate;
(c) contacting the solid substrate with an antibody which binds to the agent concurrently with the solid substrate, wherein the antibody has a mass tag cleavably affixed thereto, and wherein the contacting is performed under conditions which would permit the antibody to bind to the agent if present in the sample;
(d) removing any unbound antibody;
(e) cleaving the mass tag from any bound antibody; and
(f) detecting the presence of any cleaved mass tag,
wherein the presence of cleaved mass tag indicates that the agent is present in the sample.

4. (canceled)

5. The method of claim 1, wherein the sample is an aqueous cell suspension, a cell lysate, blood, plasma, lymph, cerebro-spinal fluid, tears, saliva, urine, synovial fluid, or a fluid derived from any of the above.

6. The method of claim 1, wherein the sample is of mammalian origin.

7. The method of claim 6, wherein the sample is of human origin.

8. The method of claim 1, wherein the sample is of avian origin.

9. The method of claim 1, wherein each antibody is a monoclonal antibody.

10. The method of claim 1, wherein the antibody is a chimeric monoclonal antibody.

11-13. (canceled)

14. The method of claim 1, wherein the solid substrate is glass, quartz, silicon, plastic, or gold.

15. (canceled)

16. The method of claim 1, wherein each first antibody is affixed to the solid substrate via a streptavidin-biotin link or via 1,3-dipolar cycloaddition.

17-18. (canceled)

19. The method of claim 1 wherein the mass tag has the structure: 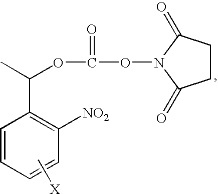
wherein X is H, F, OMe, or (OMe)₂

20. (canceled)

21. A composition of matter comprising:
(a) a solid substrate;
(b) a first antibody bound to the solid substrate, wherein the first antibody recognizes an agent;
(c) the agent recognized by the first antibody, wherein the agent is bound to the first antibody; and
(d) a second antibody which recognizes the agent bound concurrently to the first antibody, wherein the second antibody is bound to the agent, and wherein the second antibody has a mass tag cleavably affixed thereto.

22-40. (canceled)

41. The method of claim 3, wherein the sample is an aqueous cell suspension, a cell lysate, blood, plasma, lymph, cerebro-spinal fluid, tears, saliva, urine, synovial fluid, or a fluid derived from any of the above.

42. The method of claim 3, wherein the sample is of mammalian origin.

43. The method of claim 3, wherein the sample is of avian origin.

44. The method of claim 3, wherein each antibody is a monoclonal antibody.

45. The method of claim 3, wherein the antibody is a chimeric monoclonal antibody.

46. The method of claim 3, wherein the solid substrate is glass, quartz, silicon, plastic, or gold.

47. The method of claim 3 wherein the mass tag has the structure: 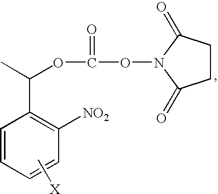
wherein X is H, F, OMe, or (OMe)₂.
